(19) United States
(12) Patent Application Publication
(10) Pub. No.: US 2005/0171948 A1
(43) Pub. Date: Aug. 4, 2005

(54) System and method for identifying critical features in an ordered scale space within a multi-dimensional feature space

(76) Inventor: William C. Knight, Bainbridge Island, WA (US)

Correspondence Address: PATRICK J S INOUYE P S, 810 3RD AVENUE, SUITE 258, SEATTLE, WA, 98104, US

(21) Appl. No.: 10/317,438

(22) Filed: Dec. 11, 2002

(51) Int. Cl. G06F 7/00; G06F 17/30; G06F 19/00

(52) U.S. Cl. 707/6; 702/19

(57) ABSTRACT

A system and method for identifying critical features in an ordered scale space within a multi-dimensional feature space is described. Features are extracted from a plurality of data collections. Each data collection is characterized by a collection of features semantically-related by a grammar. Each feature is normalized and frequencies of occurrence and co-occurrences for the feature for each of the data collections is determined. The occurrence frequencies and the co-occurrence frequencies for each of the features are mapped into a set of patterns of occurrence frequencies and a set of patterns of co-occurrence frequencies. The pattern for each data collection is selected and distance (similarity) measures between each occurrence frequency in the selected pattern is calculated. The occurrence frequencies are projected onto a one-dimensional document signal in order of relative decreasing similarity using the similarity measures. Wavelet and scaling coefficients are derived from the one-dimensional document signal using multiresolution analysis.

### FIELD OF THE INVENTION

The present invention relates in general to feature recognition and categorization and, in particular, to a system and method for identifying critical features in an ordered scale space within a multi-dimensional feature space.

### BACKGROUND OF THE INVENTION

Beginning with Gutenberg in the mid-fifteenth century, the volume of printed materials has steadily increased at an explosive pace. Today, the Library of Congress alone contains over 18 million books and 54 million manuscripts. A substantial body of printed material is also available in electronic form, in large part due to the widespread adoption of the Internet and personal computing.

Nevertheless, efficiently recognizing and categorizing notable features within a given body of printed documents remains a daunting and complex task, even when aided by automation. Efficient searching strategies have long existed for databases, spreadsheets and similar forms of ordered data. The majority of printed documents, however, are unstructured collections of individual words, which, at a semantic level, form terms and concepts, but generally lack a regular ordering or structure. Extracting or “mining” meaning from unstructured document sets consequently requires exploiting the inherent or “latent” semantic structure underlying sentences and words.

Recognizing and categorizing text within unstructured document sets presents problems analogous to other forms of data organization having latent meaning embedded in the natural ordering of individual features. For example, genome and protein sequences form patterns amenable to data mining methodologies and which can be readily parsed and analyzed to identify individual genetic characteristics. Each genome and protein sequence consists of a series of capital letters and numerals uniquely identifying a genetic code for DNA nucleotides and amino acids. Generic markers, that is, genes or other identifiable portions of DNA whose inheritance can be followed, occur naturally within a given genome or protein sequence and can help facilitate identification and categorization.

Efficiently processing a feature space composed of terms and concepts extracted from unstructured text or genetic markers extracted from genome and protein sequences both suffer from the curse of dimensionality: the dimensionality of the problem space grows proportionate to the size of the corpus of individual features. For example, terms and concepts can be mined from an unstructured document set and the frequencies of occurrence of individual terms and concepts can be readily determined. However, the frequency of occurrences increases linearly with each successive term and concept. The exponential growth of the problem space rapidly makes analysis intractable, even though much of the problem space is conceptually insignificant at a semantic level.

The high dimensionality of the problem space results from the rich feature space. The frequency of occurrences of each feature over the entire set of data (corpus for text documents) can be analyzed through statistical and similar means to determine a pattern of semantic regularity. However, the sheer number of features can unduly complicate identifying the most relevant features through redundant values and conceptually insignificant features.

Moreover, most popular classification techniques generally fail to operate in a high dimensional feature space. For instance, neural networks, Bayesian classifiers, and similar approaches work best when operating on a relatively small number of input values. These approaches fail when processing hundreds or thousands of input features. Neural networks, for example, include an input layer, one or more intermediate layers, and an output layer. With guided learning, the weights interconnecting these layers are modified by applying successive input sets and error propagation through the network. Retraining with a new set of inputs requires further training of this sort. A high dimensional feature space causes such retraining to be time consuming and infeasible.

Mapping a high-dimensional feature space to lower dimensions is also difficult. One approach to mapping is described in commonly-assigned U.S. patent application Ser. No. 09/943,918, filed Aug. 31, 2001, pending, the disclosure of which is incorporated by reference. This approach utilizes statistical methods to enable a user to model and select relevant features, which are formed into clusters for display in a two-dimensional concept space. However, logically related concepts are not ordered and conceptually insignificant and redundant features within a concept space are retained in the lower dimensional projection .

A related approach to analyzing unstructured text is described in N. E. Miller at al, “Topic Islands: A Wavelet-Based Text Visualization System,” IEEE Visualization Proc., 1998, the disclosure of which is incorporated by reference. The text visualization system automatically analyzes text to locate breaks in narrative flow. Wavelets are used to allow the narrative flow to be conceptualized in distinct channels. However, the channels do not describe individual features and do not digest an entire corpus of multiple documents.

Similarly, a variety of document warehousing and text mining techniques are described in D. Sullivan, “Document Warehousing and Text Mining-Techniques for Improving Business Operations, Marketing, and Sales,” Parts 2 and 3, John Wiley & Sons (February 2001), the disclosure of which is incorporated by reference. However, the approaches are described without focus on identifying a feature space within a larger corpus or reordering high-dimensional feature vectors to extract latent semantic meaning.

Therefore, there is a need for an approach to providing an ordered set of extracted features determined from a multi-dimensional problem space, including text documents and genome and protein sequences. Preferably, such an approach will isolate critical feature spaces while filtering out null valued, conceptually insignificant, and redundant features within the concept space.

There is a further need for an approach that transforms the feature space into an ordered scale space. Preferably, such an approach would provide a scalable feature space capable of abstraction in varying levels of detail through multiresolution analysis.

### SUMMARY OF THE INVENTION

The present invention provides a system and method for transforming a multi-dimensional feature space into an ordered and prioritized scale space representation. The scale space will generally be defined in Hilbert function space. A multiplicity of individual features are extracted from a plurality of discrete data collections. Each individual feature represents latent content inherent in the semantic structuring of the data collection. The features are organized into a set of patterns on a per data collection basis. Each pattern is analyzed for similarities and closely related features are grouped into individual clusters. In the described embodiment, the similarity measures are generated from a distance metric. The clusters are then projected into an ordered scale space where the individual feature vectors are subsequently encoded as wavelet and scaling coefficients using multiresolution analysis. The ordered vectors constitute a “semantic” signal amenable to signal processing techniques, such as compression.

An embodiment provides a system and method for identifying critical features in an ordered scale space within a multi-dimensional feature space. Features are extracted from a plurality of data collections. Each data collection is characterized by a collection of features semantically-related by a grammar. Each feature is then normalized and frequencies of occurrence and co-occurrences for the features for each of the data collections is determined. The occurrence frequencies and the co-occurrence frequencies for each of the extracted features are mapped into a set of patterns of occurrence frequencies and a set of patterns of co-occurrence frequencies. The pattern for each data collection is selected and similarity measures between each occurrence frequency in the selected pattern is calculated. The occurrence frequencies are projected onto a one-dimensional document signal in order of relative decreasing similarity using the similarity measures. Instances of high-dimensional feature vectors can then be treated as a one-dimensional signal vector. Wavelet and scaling coefficients are derived from the one-dimensional document signal.

A further embodiment provides a system and method for abstracting semantically latent concepts extracted from a plurality of documents. Terms and phrases are extracted from a plurality of documents. Each document includes a collection of terms, phrases and non-probative words. The terms and phrases are parsed into concepts and reduced into a single root word form. A frequency of occurrence is accumulated for each concept. The occurrence frequencies for each of the concepts are mapped into a set of patterns of occurrence frequencies, one such pattern per document, arranged in a two-dimensional document-feature matrix. Each pattern is iteratively selected from the document-feature matrix for each document. Similarity measures between each pattern are calculated. The occurrence frequencies, beginning from a substantially maximal similarity value, are transformed into a one-dimensional signal in scaleable vector form ordered in sequence of relative decreasing similarity. Wavelet and scaling coefficients are derived from the one-dimensional scale signal.

A further embodiment provides a system and method for abstracting semantically latent genetic subsequences extracted from a plurality of genetic sequences. Generic subsequences are extracted from a plurality of genetic sequences. Each genetic sequence includes a collection of at least one of genetic codes for DNA nucleotides and amino acids. A frequency of occurrence for each genetic subsequence is accumulated for each of the genetic sequences from which the genetic subsequences originated. The occurrence frequencies for each of the genetic subsequences are mapped into a set of patterns of occurrence frequencies, one such pattern per genetic sequence, arranged in a two-dimensional genetic subsequence matrix. Each pattern is iteratively selected from the genetic subsequence matrix for each genetic sequence. Similarity measures between each occurrence frequency in each selected pattern are calculated. The occurrence frequencies, beginning from a substantially maximal similarity measure, are projected onto a one-dimensional signal in scaleable vector form ordered in sequence of relative decreasing similarity. Wavelet and scaling coefficients are derived the one-dimensional scale signal.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for identifying critical features in an ordered scale space within a multi-dimensional feature space, in accordance with the present invention.

FIG. 2 is a block diagram showing, by way of example, a set of documents.

FIG. 3 is a Venn diagram showing, by way of example, the features extracted from the document set of FIG. 2.

FIG. 4 is a data structure diagram showing, by way of example, projections of the features extracted from the document set of FIG. 2.

FIG. 5 is a block diagram showing the software modules implementing the data collection analyzer of FIG. 1.

FIG. 6 is a process flow diagram showing the stages of feature analysis performed by the data collection analyzer of FIG. 1.

FIG. 7 is a flow diagram showing a method for identifying critical features in an ordered scale space within a multi-dimensional feature space, in accordance with the present invention.

FIG. 8 is a flow diagram showing the routine for performing feature analysis for use in the method of FIG. 7.

FIG. 9 is a flow diagram showing the routine for determining a frequency of concepts for use in the routine of FIG. 8.

FIG. 10 is a data structure diagram showing a database record for a feature stored in the database of FIG. 1.

FIG. 11 is a data structure diagram showing, by way of example, a database table containing a lexicon of extracted features stored in the database of FIG. 1.

FIG. 12 is a graph showing, by way of example, a histogram of the frequencies of feature occurrences generated by the routine of FIG. 9.

FIG. 13 is a graph showing, by way of example, an increase in a number of features relative to a number of data collections.

FIG. 14 is a table showing, by way of example, a matrix mapping of feature frequencies generated by the routine of FIG. 9.

FIG. 15 is a graph showing, by way of example; a corpus graph of the frequency of feature occurrences generated by the routine of FIG. 9.

FIG. 16 is a flow diagram showing a routine for transforming a problem space into a scale space for use in the routine of FIG. 8.

FIG. 17 is a flow diagram showing the routine for generating similarity measures and forming clusters for use in the routine of FIG. 16.

FIG. 18 is a table showing, by way of example, the feature clusters created by the routine of FIG. 17

FIG. 19 is a flow diagram showing a routine for identifying critical features for use in the method of FIG. 7.

### DETAILED DESCRIPTION

### Glossary

Document: A base collection of data used for analysis as a data set.

Instance: A base collection of data used for analysis as a data set. In the described embodiment, an instance is generally equivalent to a document.

Document Vector: A set of feature values that describe a document.

Document Signal: Equivalent to a document vector.

Scale Space: Generally referred to as Hilbert function space H.

Keyword: A literal search term which is either present or absent from a document or data collection. Keywords are not used in the evaluation of documents and data collections as described here.

Term: A root stem of a single word appearing in the body of at least one document or data collection. Analogously, a genetic marker in a genome or protein sequence

Phrase: Two or more words co-occurring in the body of a document or data collection. A phrase can include stop words.

Feature: A collection of terms or phrases with common semantic meanings, also referred to as a concept.

Theme: Two or more features with a common semantic meaning.

Cluster: All documents or data collections that falling within a predefined measure of similarity.

Corpus: All text documents that define the entire raw data set.

The foregoing terms are used throughout this document and, unless indicated otherwise, are assigned the meanings presented above. Further, although described with reference to document analysis, the terms apply analogously to other forms of unstructured data, including genome and protein sequences and similar data collections having a vocabulary, grammar and atomic data units, as would be recognized by one skilled in the art.

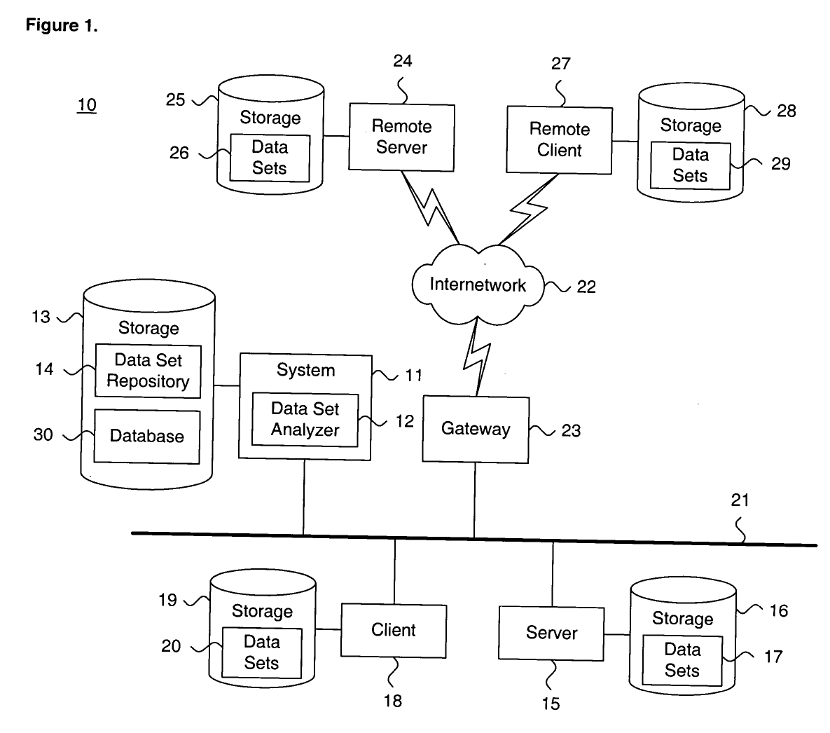

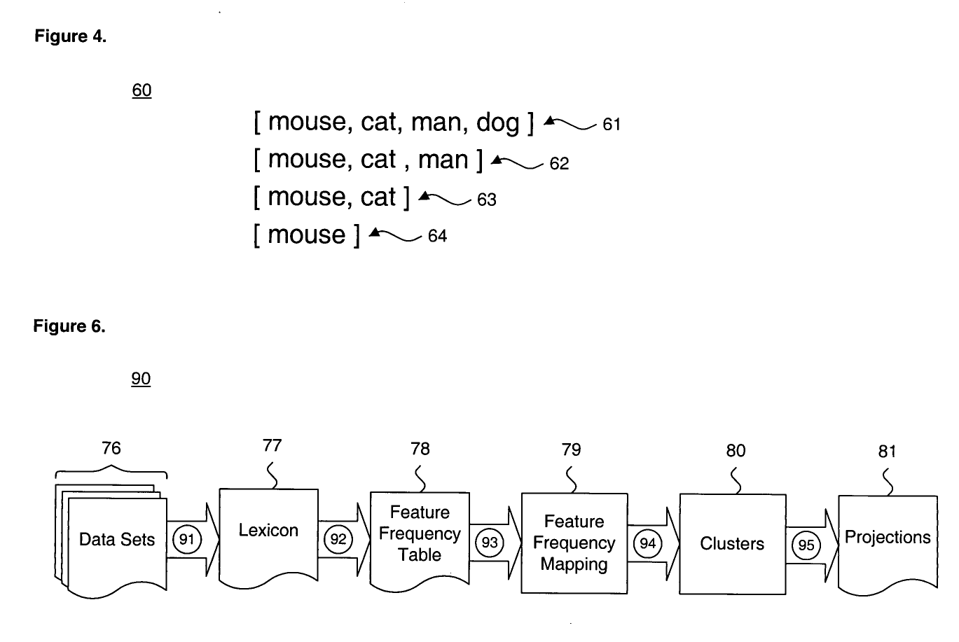

FIG. 1 is a block diagram showing a system 11 for identifying critical features in an ordered scale space within a multi-dimensional feature space, in accordance with the present invention. The scale space is also known as Hilbert function space. By way of illustration, the system 11 operates in a distributed computing environment 10, which includes a plurality of heterogeneous systems and data collection sources. The system 11 implements a data collection analyzer 12, as further described below beginning with reference to FIG. 4, for evaluating latent semantic features in unstructured data collections. The system 11 is coupled to a storage device 13 which stores a data collections repository 14 for archiving the data collections and a database 30 for maintaining data collection feature information.

The document analyzer 12 analyzes data collections retrieved from a plurality of local sources. The local sources include data collections 17 maintained in a storage device 16 coupled to a local server 15 and data collections 20 maintained in a storage device 19 coupled to a local client 18. The local server 15 and local client 18 are interconnected to the system 11 over an intranetwork 21. In addition, the data collection analyzer 12 can identify and retrieve data collections from remote sources over an internetwork 22, including the Internet, through a gateway 23 interfaced to the intranetwork 21. The remote sources include data collections 26 maintained in a storage device 25 coupled to a remote server 24 and data collections 29 maintained in a storage device 28 coupled to a remote client 27.

The individual data collections 17, 20; 26, 29 each constitute a semantically- related collection of stored data, including all forms and types of unstructured and semi-structured (textual) data, including electronic message stores, such as electronic mail (email) folders, word processing documents or Hypertext documents, and could also include graphical or multimedia data. The unstructured data also includes genome and protein sequences and similar data collections. The data collections include some form of vocabulary with which atomic data units are defined and features are semantically-related by a grammar, as would be recognized by one skilled in the art. An atomic data unit is analogous to a feature and consists of one or more searchable characteristics which, when taken singly or in combination, represent a grouping having a common semantic meaning. The grammar allows the features to be combined syntactically and semantically and enables the discovery of latent semantic meanings. The documents could also be in the form of structured data, such as stored in a spreadsheet or database. Content mined from these types of documents will not require preprocessing, as described below.

In the described embodiment, the individual data collections 17, 20, 26, 29 include electronic message folders, such as maintained by the Outlook and Outlook Express products, licensed by Microsoft Corporation, Redmond, Wash. The database is an SQL-based relational database, such as the Oracle database management system, Release 8, licensed by Oracle Corporation, Redwood Shores, Calif.

The individual computer systems, including system 11, server 15, client 18, remote server 24 and remote client 27, are general purpose, programmed digital computing devices consisting of a central processing unit (CPU), random access memory (RAM), non-volatile secondary storage, such as a hard drive or CD ROM drive, network or wireless interfaces, and peripheral devices, including user interfacing means, such as a keyboard and display. Program code, including software programs, and data are loaded into the RAM for execution and processing by the CPU and results are generated for display, output, transmittal, or storage.

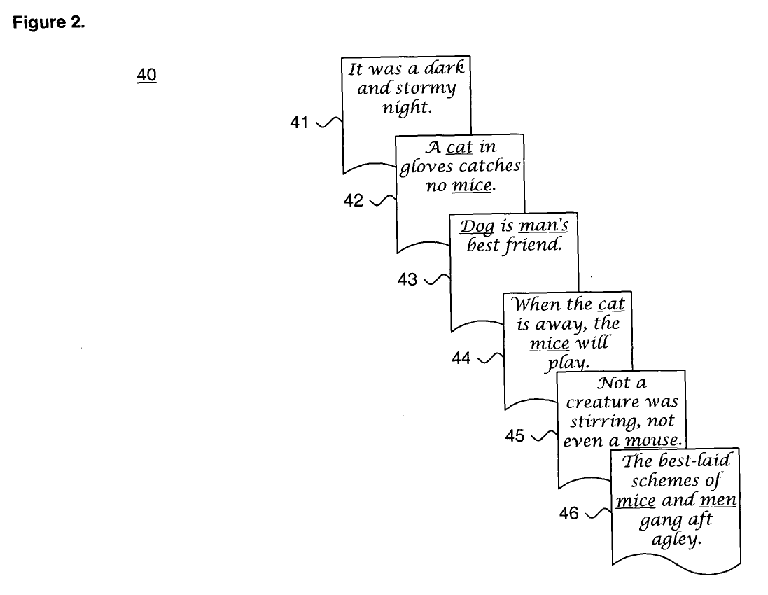

The complete set of features extractable from a given document or data collection can be modeled in a logical feature space, also referred to as Hilbert function space H. The individual features form a feature set from which themes can be extracted. For purposes of illustration, FIG. 2 is a block diagram showing, by way of example, a set 40 of documents 41-46. Each individual document 41-46 comprises a data collection composed of individual terms. For instance, documents 42, 44, 45, and 46 respectively contain “mice,” “mice,” “mouse,” and “mice,” the root stem of which is “mouse.” Similarly, documents 42 and 43 both contain “cat;” documents 43 and 46 respectively contain “man's” and “men,” the root stem of which is “man;” and document 43 contains “dog.” Each set of terms constitutes a feature. Documents 42, 44, 45, and 46 contain the term “mouse” as a feature. Similarly, documents 42 and 43 contain the term “cat,” documents 43 and 46 contain the term “man,” and document 43 contains the term “dog” as a feature. Thus, features “mouse,” “cat,” “man,” and “dog” form the corpus of the document set 40.

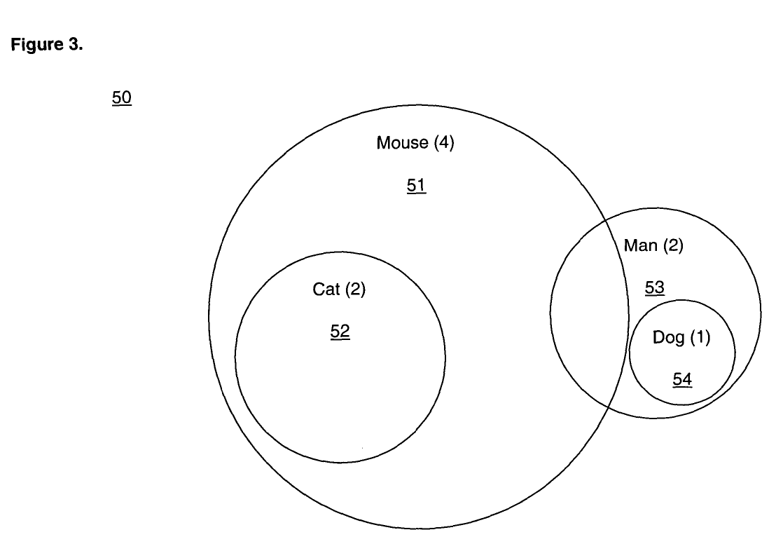

FIG. 3 is a Venn diagram 50 showing, by way of example, the features 51-54 extracted from the document set 40 of FIG. 2. The feature “mouse” occurs four times in the document set 40. Similarly, the features “cat,” “man,” and “dog” respectively occur two times, two times, and one time. Further, the features “mouse” and “cat” consistently co-occur together in the document set 40 and form a theme, “mouse and cat.” “Mouse” and “man” also co-occur and form a second theme, “mouse and man.” “Man” and “dog” co-occur and form a third theme, “man and dog.” The Venn diagram diagrammatically illustrates the interrelationships of the thematic co-occurrences in two dimensions and reflects that “mouse and cat” is the strongest theme in the document set 40.

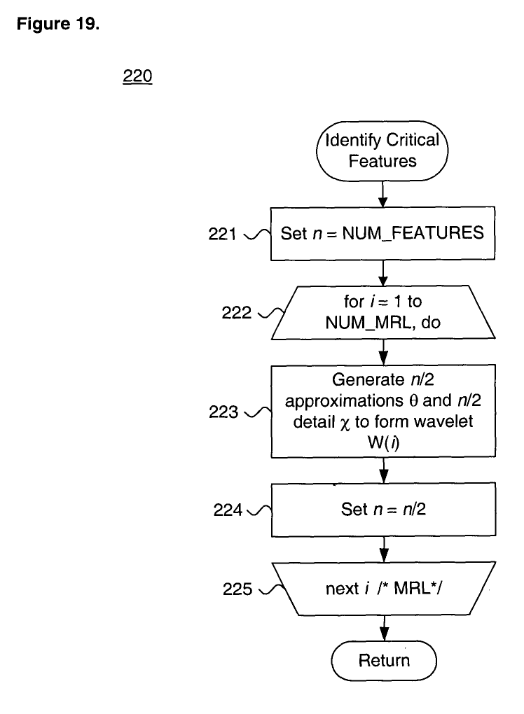

Venn diagrams are two-dimensional representations, which can only map thematic overlap along a single dimension. As further described below beginning with reference to FIG. 19, the individual features can be more accurately modeled as clusters in a multi-dimensional feature space. In turn, the clusters can be projected onto an ordered and prioritized one-dimensional feature vectors, or projections, modeled in Hilbert function space H reflecting the relative strengths of the interrelationships between the respective features and themes. The ordered feature vectors constitute a “semantic” signal amenable to signal processing techniques, such as quantization and encoding.

FIG. 4 is a data structure diagram showing, by way of example, projections 60 of the features extracted from the document set 40 of FIG. 2. The projections 60 are shown in four levels of detail 61-64 in scale space. In the highest or most detailed level 61, all related features are described in order of decreasing interrelatedness. For instance, the feature “mouse” is most related to the feature “cat” than to features “man” and “dog.” As well, the feature “mouse” is also more related to feature “man” than to feature “dog.” The feature “dog” is the least related feature.

At the second highest detail level 62, the feature “dog” is omitted. Similarly, in the third and fourth detail levels 63, 64, the features “man” and “cat” are respectively omitted. The fourth detail level 64 reflects the most relevant feature present in the document set 40, “mouse,” which occurs four times, and therefore abstracts the corpus at a minimal level.

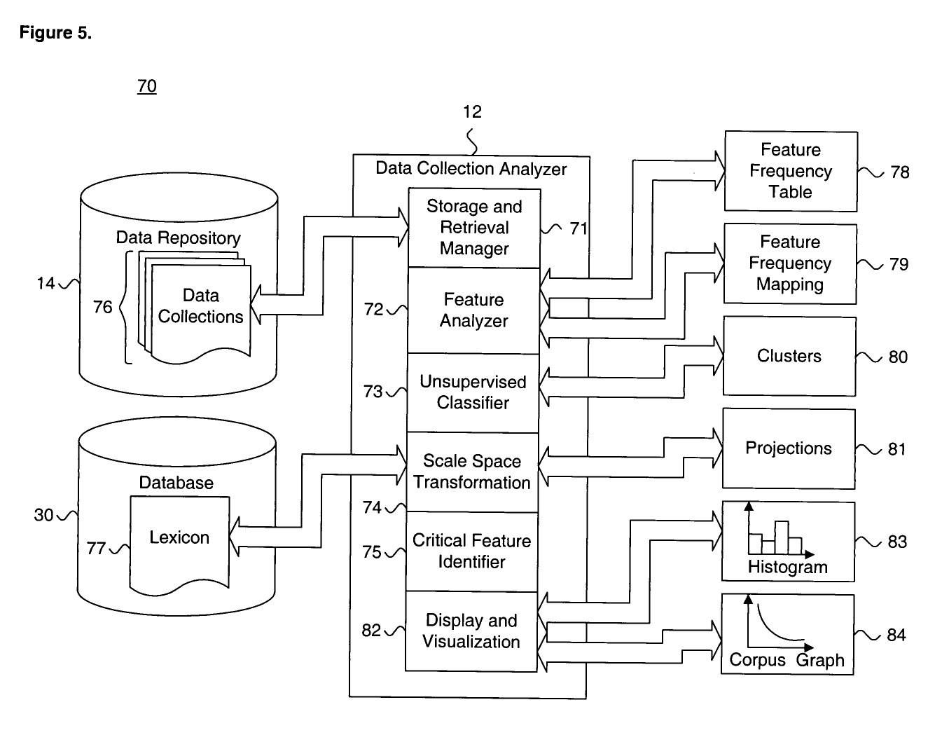

FIG. 5 is a block diagram showing the software modules 70 implementing the data collection analyzer 12 of FIG. 1. The data collection analyzer 12 includes six modules: storage and retrieval manager 71, feature analyzer 72, unsupervised classifier 73, scale space transformation 74, critical feature identifier 75, and display and visualization 82. The storage and retrieval manager 71 identifies and retrieves data collections 76 into the data repository 14. The data collections 76 are retrieved from various sources, including local and remote clients and server stores. The feature analyzer 72 performs the bulk of the feature mining processing. The unsupervised classifier 73 processes patterns of frequency occurrences expressed in feature space into reordered vectors expressed in scale space. The scale space transformation 74 abstracts the scale space vectors into varying levels of detail with, for instance, wavelet and scaling coefficients, through multiresolution analysis. The display and visualization 82 complements the operations performed by the feature analyzer 72, unsupervised classifier 73, scale space transformation 74, and critical feature identifier 75 by presenting visual representations of the information extracted from the data collections 76. The display and visualization 82 can also generate a graphical representation of the mixed and processed features, which preserves independent variable relationships, such as described in common-assigned U.S. patent application Ser. No. 09/944,475, filed Aug. 31, 2001, pending, the disclosure of which is incorporated by reference.

During text analysis, the feature analyzer 72 identifies terms and phrases and extracts features in the form of noun phrases, genome or protein markers, or similar atomic data units, which are then stored in a lexicon 77 maintained in the database 30. After normalizing the extracted features, the feature analyzer 72 generates a feature frequency table 78 of inter-document feature occurrences and an ordered feature frequency mapping matrix 79, as further described below with reference to FIG. 14. The feature frequency table 78 maps the occurrences of features on a per document basis and the ordered feature frequency mapping matrix 79 maps the occurrences of all features over the entire corpus or data collection.

The unsupervised classifier 73 generates logical clusters 80 of the extracted features in a multi-dimensional feature space for modeling semantic meaning. Each cluster 80 groups semantically-related themes based on relative similarity measures, for instance, in terms of a chosen L² distance metric.

In the described embodiment, the L² distance metrics are defined in L² function space, which is the space of absolutely square integrable functions, such as described in B. B. Hubbard, “The World According to Wavelets, The Story of a Mathematical Technique in the Making,” pp. 227-229, A. K. Peters (2d ed. 1998), the disclosure of which is incorporated by reference. The L² distance metric is equivalent to the Euclidean distance between two vectors. Other distance measures include correlation, direction cosines, Minkowski metrics, Tanimoto similarity measures, Mahanobis distances, Hamming distances, Levenshtein distances, maximum probability distances, and similar distance metrics as are known in the art, such as described in T. Kohonen, “Self-Organizing Maps,” Ch. 1.2, Springer-Verlag (3d ed. 2001), the disclosure of which is incorporated by reference.

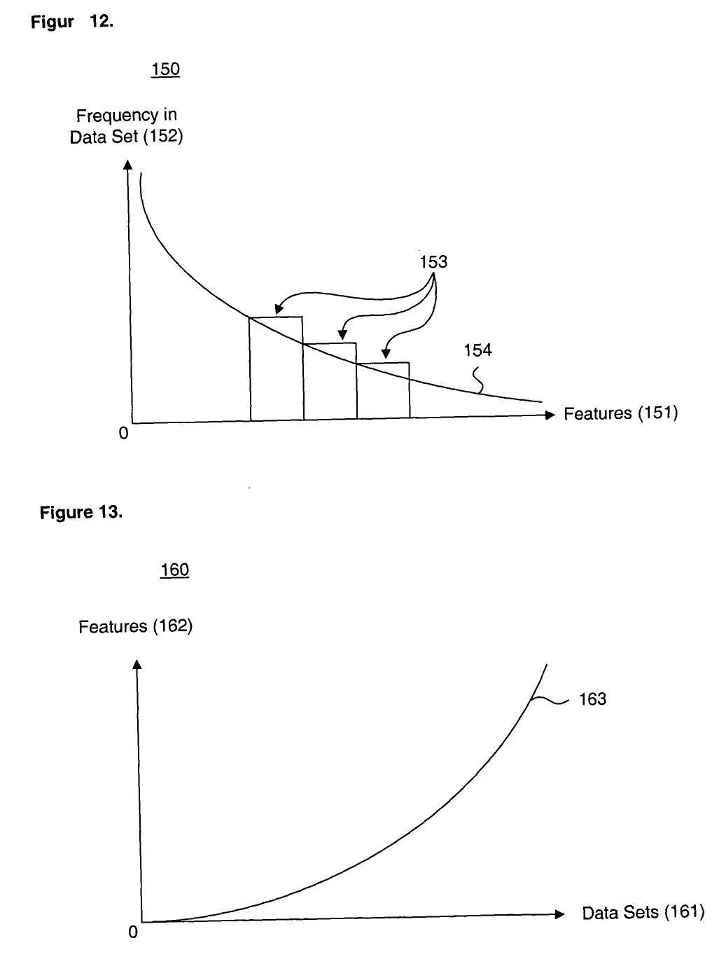

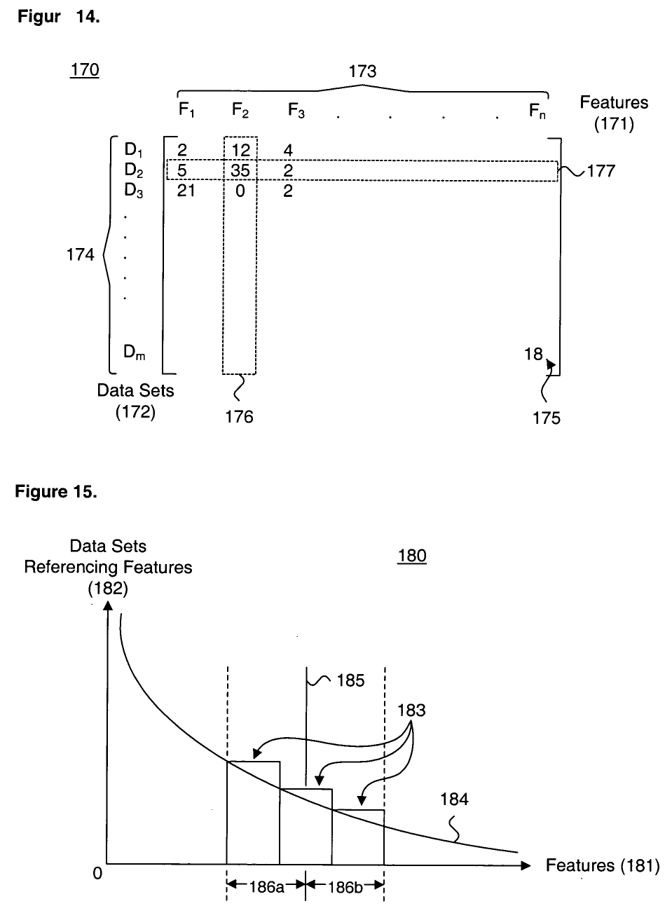

The scale space transformation 74 forms projections 81 of the clusters 80 into one-dimensional ordered and prioritized scale space. The projections 81 are formed using wavelet and scaling coefficients (not shown). The critical feature identifier 75 derives wavelet and scaling coefficients from the one-dimensional document signal. Finally, the display and visualization 82 generates a histogram 83 of feature occurrences per document or data collection, as further described below with reference to FIG. 13, and a corpus graph 84 of feature occurrences over all data collections, as further described below with reference to FIG. 15.

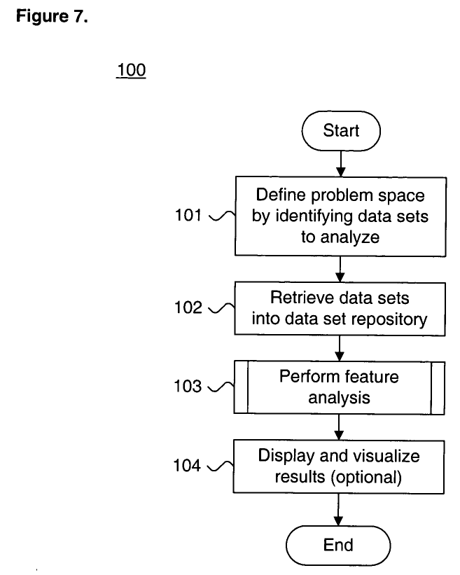

Each module is a computer program, procedure or module written as source code in a conventional programming language, such as the C++, programming language, and is presented for execution by the CPU as object or byte code, as is known in the art. The various implementations of the source code and object and byte codes can be held on a computer-readable storage medium or embodied on a transmission medium in a carrier wave. The data collection analyzer 12 operates in accordance with a sequence of process steps, as further described below with reference to FIG. 7.

FIG. 6 is a process flow diagram showing the stages 90 of feature analysis performed by the data collection analyzer 12 of FIG. 1. The individual data collections 76 are preprocessed and noun phrases, genome and protein markers, or similar atomic data units, are extracted as features (transition 91) into the lexicon 77. The features are normalized and queried (transition 92) to generate the feature frequency table 78. The feature frequency table 78 identifies individual features and respective frequencies of occurrence within each data collection 76. The frequencies of feature occurrences are mapped (transition 93) into the ordered feature frequency mapping matrix 79, which associates the frequencies of occurrence of each feature on a per-data collection basis over all data collections. The features are formed (transition 94) into clusters 80 of semantically-related themes based on relative similarity measured, for instance, in terms of the distance measure. Finally, the clusters 80 are projected (transition 95) into projections 81, which are reordered and prioritized into one-dimensional document signal vectors.

FIG. 7 is a flow diagram showing a method 100 for identifying critical features in an ordered scale space within a multi-dimensional feature space 40 (shown in FIG. 2), in accordance with the present invention. As a preliminary step, the problem space is defined by identifying the data collection to analyze (block 101). The problem space could be any collection of structured or unstructured data collections, including documents or genome or protein sequences, as would be recognized by one skilled in the art. The data collections 41 are retrieved from the data repository 14 (shown in FIG. 1) (block 102).

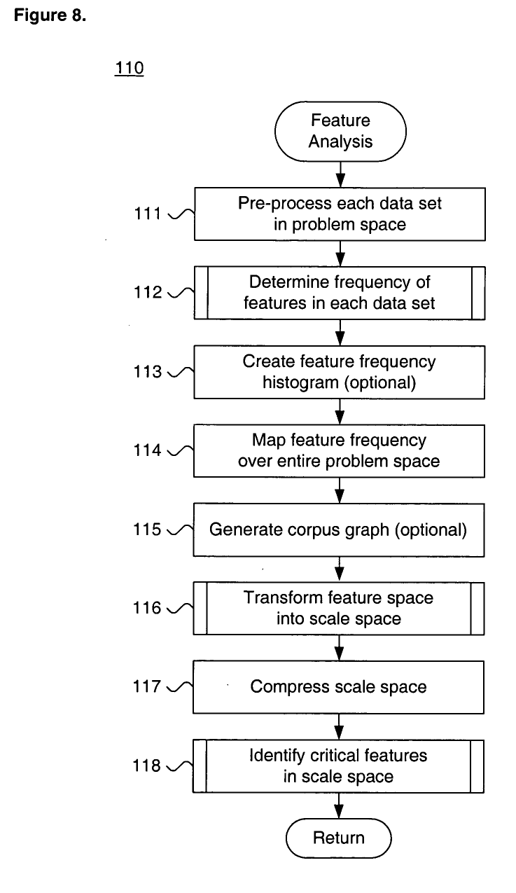

Once identified and retrieved, the data collections 41 are analyzed for features (block 103), as further described below with reference to FIG. 8. During feature analysis, an ordered matrix 79 mapping the frequencies occurrence of extracted features (shown below in FIG. 14) is constructed to summarize the semantic content inherent in the data collections 41. Finally, the semantic content extracted from the data collections 41 can optionally be displayed and visualized graphically (block 104), such as described in commonly-assigned U.S. patent application Ser. No. 09/944,475, filed Aug. 31, 2001, pending; U.S. patent application Ser. No. 09/943,918, filed Aug. 31, 2001, pending; and U.S. patent application Ser. No. 10/084,401, filed Feb. 25, 2002, pending, the disclosures are which are incorporated by reference. The method then terminates.

FIG. 8 is a flow diagram showing the routine 110 for performing feature analysis for use in the method 100 of FIG. 7. The purpose of this routine is to extract and index features from the data collections 41. In the described embodiment, terms and phrases are extracted typically from documents. Document features might also include paragraph count, sentences, date, title, folder, author, subject, abstract, and so forth. For genome or protein sequences, markers are extracted. For other forms of structured or unstructured data, atomic data units characteristic of semantic content are extracted, as would be recognized by one skilled in the art.

Preliminarily, each data collection 41 in the problem space is preprocessed (block 111) to remove stop words or similar atomic non-probative data units. For data collections 41 consisting of documents, stop words include commonly occurring words, such as indefinite articles (“a” and “an”), definite articles (“the”), pronouns (“I”, “he” and “she”), connectors (“and” and “or”), and similar non-substantive words. For genome and protein sequences, stop words include non-marker subsequence combinations. Other forms of stop words or non-probative data units may require removal or filtering, as would be recognized by one skilled in the art.

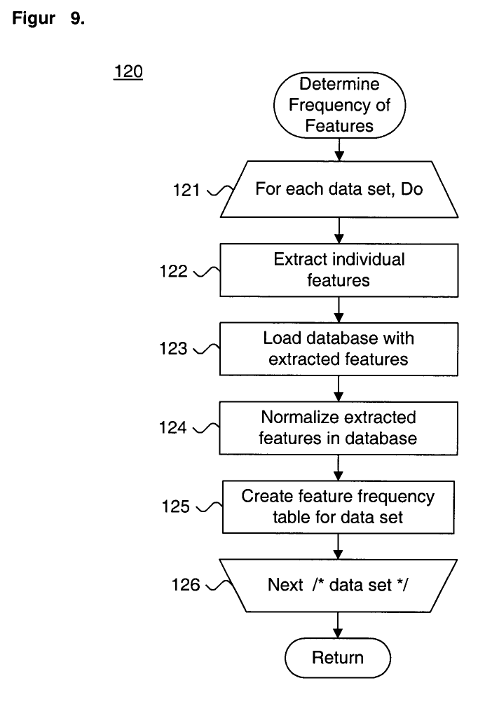

Following preprocessing, the frequency of occurrences of features for each data collection 41 is determined (block 112), as further described below with reference to FIG. 9. Optionally, a histogram 83 of the frequency of feature occurrences per document or data collection (shown in FIG. 4) is logically created (block 113). Each histogram 83, as further described below with reference to FIG. 13, maps the relative frequency of occurrence of each extracted feature on a per-document basis. Next, the frequency of occurrences of features for all data sets 41 is mapped over the entire problem space (block 114) by creating an ordered feature frequency mapping matrix 79, as further described below with reference to FIG. 14. Optionally, a frequency of feature occurrences graph 84 (shown in FIG. 4) is logically created (block 115). The corpus graph, as further described below with reference to FIG. 15, is created for all data sets 41 and graphically maps the semantically-related concepts based on the cumulative occurrences of the extracted features.

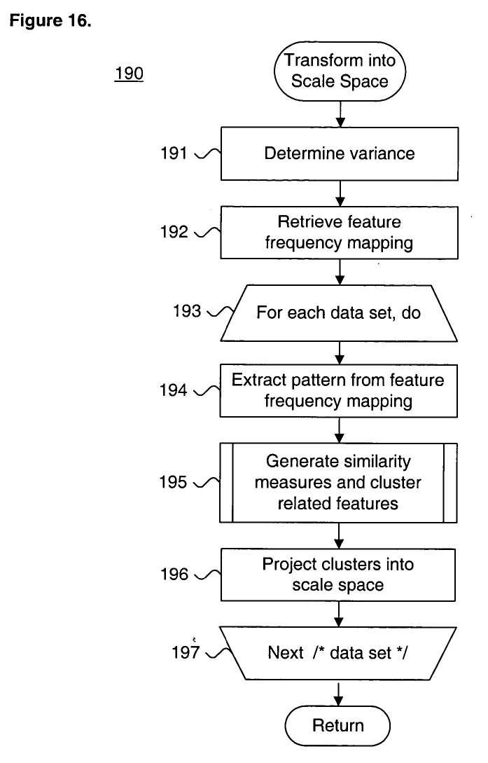

Multiresolution analysis is performed on the ordered frequency mapping matrix 79 (block 116), as further described below with reference to FIG. 16. Cluster reordering generates a set of ordered vectors, which each constitute a “semantic” signal amenable to conventional signal processing techniques. Thus, the ordered vectors can be analyzed, such as through multiresolution analysis, quantized (block 117) and encoded (block 118), as is known in the art. The routine then returns.

FIG. 9 is a flow diagram showing the routine 120 for determining a frequency of concepts for use in the routine of FIG. 8. The purpose of this routine is to extract individual features from each data collection and to create a normalized representation of the feature occurrences and co-occurrences on a per-data collection basis. In the described embodiment, features for documents are defined on the basis of the extracted noun phrases, although individual nouns or tri-grams (word triples) could be used in lieu of noun phrases. Terms and phrases are typically extracted from the documents using the LinguistX product licensed by Inxight Software, Inc., Santa Clara, Calif. Other document features could also be extracted, including paragraph count, sentences, date, title, directory, folder, author, subject, abstract, verb phrases, and so forth. Genome and protein sequences are similarly extracted using recognized protein and amino markers, as are known in the art.

Each data collection is iteratively processed (blocks 121-126) as follows. Initially, individual features, such as noun phrases or genome and protein sequence markers, are extracted from each data collection 41 (block 122). Once extracted, the individual features are loaded into records stored in the database 30 (shown in FIG. 1) (block 123). The features stored in the database 30 are normalized (block 124) such that each feature appears as a record only once. In the described embodiment, the records are normalized into third normal form, although other normalization schemas could be used. A feature frequency table 78 (shown in FIG. 5) is created for the data collection 41 (block 125). The feature frequency table 78 maps the number of occurrences and co-occurrences of each extracted feature for the data collection. Iterative processing continues (block 126) for each remaining data collection 41, after which the routine returns.

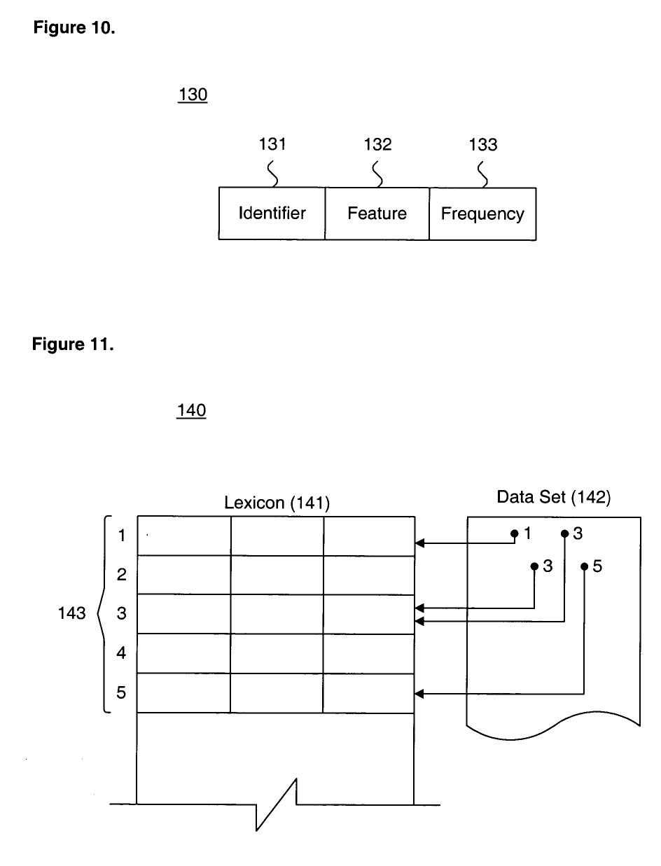

FIG. 10 is a data structure diagram showing a database record 130 for a feature stored in the database 30 of FIG. 1. Each database record 130 includes fields for storing an identifier 131, feature 132 and frequency 133. The identifier 131 is a monotonically increasing integer value that uniquely identifies the feature 132 stored in each record 130. The identifier 131 could equally be any other form of distinctive label, as would be recognized by one skilled in the art. The frequency of occurrence of each feature is tallied in the frequency 133 on both per-instance collection and entire problem space bases.

FIG. 11 is a data structure diagram showing, by way of example, a database table 140 containing a lexicon 141 of extracted features stored in the database 30 of FIG. 1. The lexicon 141 maps the individual occurrences of identified features 143 extracted for any given data collection 142. By way of example, the data collection 142 includes three features, numbered 1, 3 and 5. Feature 1 occurs once in data collection 142, feature 3 occurs twice, and feature 5 also occurs once. The lexicon tallies and represents the occurrences of frequency of the features 1, 3 and 5 across all data collections 44 in the problem space.

The extracted features in the lexicon 141 can be visualized graphically. FIG. 12 is a graph showing, by way of example, a histogram 150 of the frequencies of feature occurrences generated by the routine of FIG. 9. The x-axis defines the individual features 151 for each document and the y-axis defines the frequencies of occurrence of each feature 152. The features are mapped in order of decreasing frequency 153 to generate a curve 154 representing the semantic content of the document 44. Accordingly, features appearing on the increasing end of the curve 154 have a high frequency of occurrence while features appearing on the descending end of the curve 154 have a low frequency of occurrence.

Referring back to FIG. 11, the lexicon 141 reflects the features for individual data collections and can contain a significant number of feature occurrences, depending upon the size of the data collection. The individual lexicons 141 can be logically combined to form a feature space over all data collections. FIG. 13 is a graph 160 showing, by way of example, an increase in a number of features relative to a number of data collections. The x-axis defines the data collections 161 for the problem space and the y-axis defines the number of features 162 extracted. Mapping the feature space (number of features 162) over the problem space (number of data collections 161) generates a curve 163 representing the cumulative number of features, which increases 163 proportional to the number of data collections 161. Each additional extracted feature produces a new dimension within the feature space, which, without ordering and prioritizing, poorly abstracts semantic content in an efficient manner.

FIG. 14 is a table showing, by way of example, a matrix mapping of feature frequencies 170 generated by the routine of FIG. 9. The feature frequency mapping matrix 170 maps features 173 along a horizontal dimension 171 and data collections 174 along a vertical dimension 172, although the assignment of respective dimensions is arbitrary and can be inversely reassigned, as would be recognized by one skilled in the art. Each cell 175 within the matrix 170 contains the cumulative number of occurrences of each feature 173 within a given data collection 174. According, each feature column constitutes a feature set 176 and each data collection row constitutes an instance or pattern 177. Each pattern 177 represents a one-dimensional signal in scaleable vector form and conceptually insignificant features within the pattern 177 represent noise.

FIG. 15 is a graph showing, by way of example, a corpus graph 180 of the frequency of feature occurrences generated by the routine of FIG. 9. The graph 180 visualizes the extracted features as tallied in the feature frequency mapping matrix 170 (shown in FIG. 14). The x-axis defines the individual features 181 for all data collections and the y-axis defines the number of data collections 41 referencing each feature 182. The individual features are mapped in order of descending frequency of occurrence 183 to generate a curve 184 representing the latent semantics of the set of data collections 41. The curve 184 is used to generate clusters, are projected onto an ordered and prioritized one-dimensional projections in Hilbert function space.

During cluster formation, a median value 185 is selected and edge conditions 186a-b are established to discriminate between features which occur too frequently versus features which occur too infrequently. Those data collections falling within the edge conditions 186a-b form a subset of data collections containing latent features. In the described embodiment, the median value 185 is data collection-type dependent. For efficiency, the upper edge condition 186b is set to 70% and a subset of the features immediately preceding the upper edge condition 186b are selected, although other forms of threshold discrimination could also be used.

FIG. 16 is a flow diagram 190 showing a routine for transforming a problem space into a scale space for use in the routine of FIG. 8. The purpose of this routine is to create clusters 80 (shown in FIG. 4) that are used to form one-dimensional projections 81 (shown in FIG. 4) in scale space from which critical features are identified.

Briefly, a single cluster is created initially and additional clusters are added using some form of unsupervised clustering, such as simple clustering, hierarchical clustering, splitting methods, and merging methods, such as described in T. Kohonen, Ibid. at Ch. 1.3, the disclosure of which is incorporated by reference. The form of clustering used is not critical and could be any other form of unsupervised training as is known in the art. Each cluster consists of those data collections that share related features as measured by some distance metric mapped in the multi-dimensional feature space. The clusters are projected onto one-dimensional ordered vectors, which are encoded as wavelet and scaling coefficients and analyzed for critical features.

Initially, a variance specifying an upper bound on the distance measure in the multi-dimensional feature space is determined (block 191). In the described embodiment, a variance of five percent is specified, although other variance values, either greater or lesser than five percent, could be used as appropriate. Those clusters falling outside the pre-determined variance are grouped into separate clusters, such that the features are distributed over a meaningful range of clusters and every instance in the problem space appears in at least one cluster.

The feature frequency mapping matrix 170 (shown in FIG. 14) is then retrieved (block 192). The ordered feature frequency mapping matrix 79 is expressed in a multi-dimensional feature space. Each feature creates a new dimension, which increases the feature space size linearly with each successively extracted feature. Accordingly, the data collections are iteratively processed (blocks 193-197) to transform the multi-dimensional feature space into a single dimensional document vector (signal), as follows. During each iteration (block 193), a pattern 177 for the current data collection is extracted from the feature frequency mapping matrix 170 (block 194). Similarity measures are generated from the pattern 177 and related features are formed into clusters 80 (shown in FIG. 5) (block 195) using some form of unsupervised clustering, as described above. Those features falling within the pre-determined variance, as measured as measured by the distance metric, are identified and grouped into the same cluster, while those features falling outside the pre-determined variance are assigned to another cluster.

Next, the clusters 80 in feature space are each projected onto a one-dimensional signal in scaleable vector form (block 196). The ordered vectors constitute a “semantic” signal amenable to signal processing techniques, such as multiresolution analysis. In the described embodiment, the clusters 80 are projected by iteratively ordering the features identified to each cluster into the vector 61. Alternatively, cluster formation (block 195) and projection (block 196) could be performed in a single set of operations using a self-organizing map, such as described in T. Kohonen, Ibid. at Ch. 3, the disclosure of which is incorporated by reference. Other methodologies for generating similarity measures, forming clusters, and projecting into scale space could apply equally and substituted for or perform in combination with the foregoing described approaches, as would be recognized by one skilled in the art. Iterative processing then continues (block 197) for each remaining next data collection, after which the routine returns.

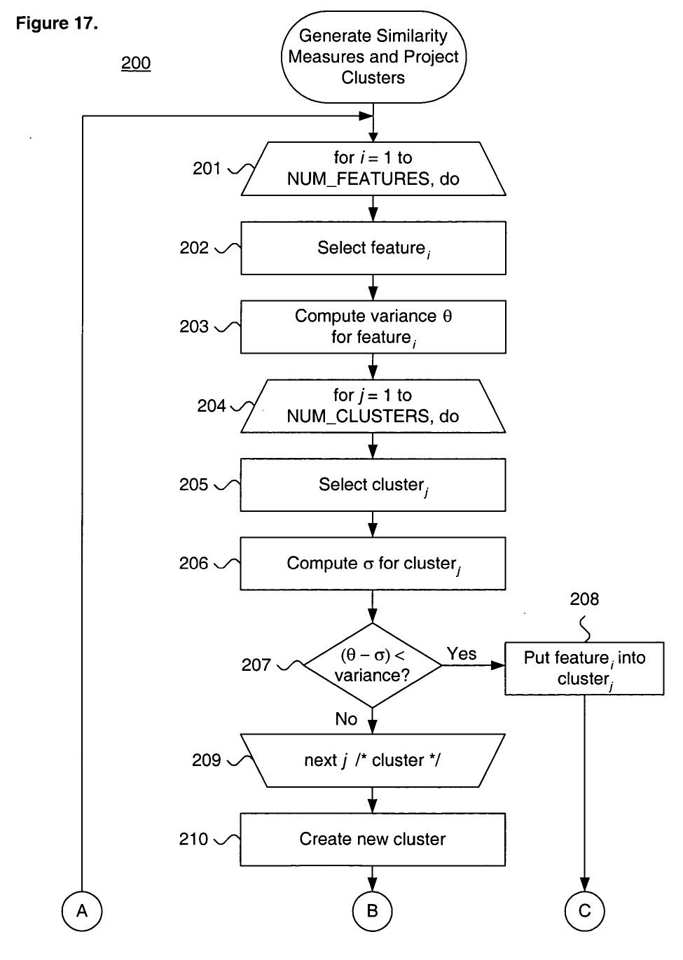

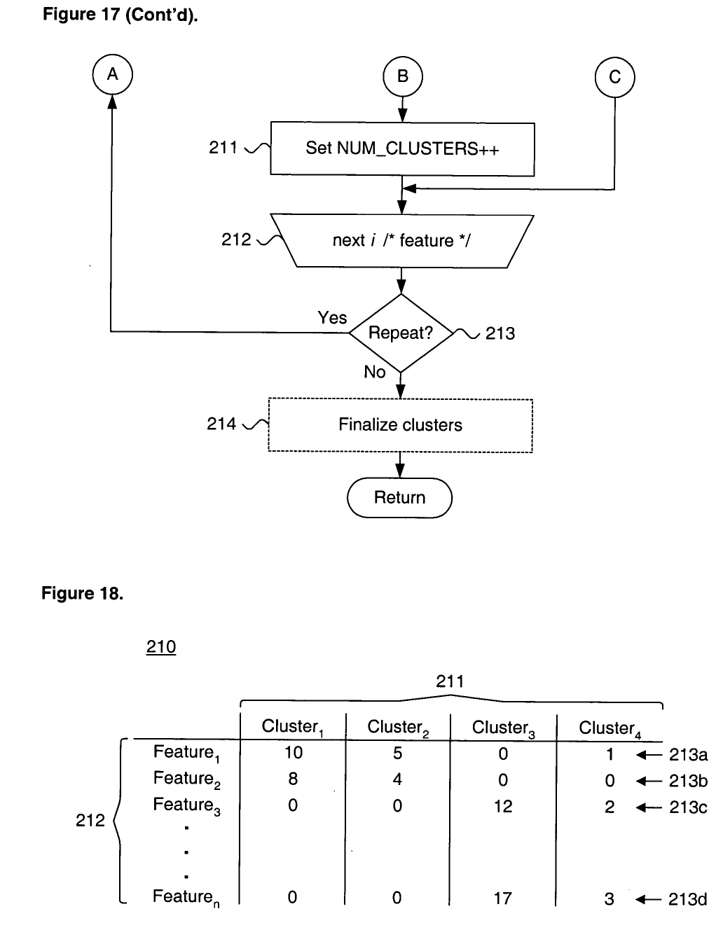

FIG. 17 is a flow diagram 200 showing the routine for generating similarity measures and forming clusters for use in the routine of FIG. 16. The purpose of this routine is to identify those features closest in similarity within the feature space and to group two or more sets of similar features into individual clusters. The clusters enable visualization of the multi-dimensional feature space.

Features and clusters are iteratively processed in a pair of nested loops (blocks 201-212 and 204-209). During each iteration of the outer processing loop (blocks 201-212), each feature i is processed (block 201). The feature i is first selected (block 202) and the variance θ for feature i is computed (block 203).

During each iteration of the inner processing loop (block 204-209), each cluster j is processed (block 204). The cluster j is selected (block 205) and the angle σ relative to the common origin is computed for the cluster j (block 206). Note the angle σ must be recomputed regularly for each cluster j as features are added or removed from clusters. The difference between the angle θ for the feature i and the angle σ for the cluster j is compared to the predetermined variance (block 207). If the difference is less than the predetermined variance (block 207), the feature i is put into the cluster j (block 208) and the iterative processing loop (block 204-209) is terminated. If the difference is greater than or equal to the variance (block 207), the next cluster j is processed (block 209) until all clusters have been processed (blocks 204-209).

If the difference between the angle θ for the feature i and the angle σ for each of the clusters exceeds the variance, a new cluster is created (block 210) and the counter num_clusters is incremented (block 211). Processing continues with the next feature i (block 212) until all features have been processed (blocks 201-212). The categorization of clusters is repeated (block 213) if necessary. In the described embodiment, the cluster categorization (blocks 201-212) is repeated at least once until the set of clusters settles. Finally, the clusters can be finalized (block 214) as an optional step. Finalization includes merging two or more clusters into a single cluster, splitting a single cluster into two or more clusters, removing minimal or outlier clusters, and similar operations, as would be recognized by one skilled in the art. The routine then returns.

FIG. 18 is a table 210 showing, by way of example, the feature clusters created by the routine of FIG. 17. Ideally, each of the features 211 should appear in at least one of the clusters 212, thereby ensuring that each data collection appears in some cluster. The distance calculations 213a-d between the data collections for a given feature are determined. Those distance values 213a-d falling within a predetermined variance are assigned to each individual cluster. The table 210 can be used to visualize the clusters in a multi-dimensional feature space.

FIG. 19 is a flow diagram showing a routine for identifying critical features for use in the method of FIG. 7. The purpose of this routine is to transform the scale space vectors into varying levels of detail with wavelet and scaling coefficients through multiresolution analysis. Wavelet decomposition is a form of signal filtering that provides a coarse summary of the original data and details lost during decomposition, thereby allowing the data stream to express multiple levels of detail. Each wavelet and scaling coefficent is formed through multiresolution analysis, which typically halves the data stream during each recursive step.

Thus, the size of the one-dimensional ordered vector 61 (shown in FIG. 4) is determined by the total number of features n in the feature space (block 221). The vector 61 is then iteratively processed (blocks 222-225) through each multiresolution level as follows. First, n/2 wavelet coefficients and n/2 scaling functions φ are generated from the vector 61 to form a wavelet coefficients and scaling coefficients. In the described-embodiment, the wavelet and scaling coefficients are generated by convolving the wavelet ψ and scaling φ functions with the ordered document vectors into a contiguous set of values in the vector 61. Other methodologies for convolving wavelet ψ and scaling φ functions could also be used, as would be recognized by one skilled in the art.

Following the first iteration of the wavelet and scaling coefficient generation, the number of features n is down-sampled (block 224) and each remaining multiresolution level is iteratively processed (blocks 222-225) until the desired minimum resolution of the signal is achieved. The routine then returns.

While the invention has been particularly shown and described as referenced to the embodiments thereof, those skilled in the art will understand that the foregoing and other changes in form and detail may be made therein without departing from the spirit and scope of the invention.

1. A system for identifying critical features in an ordered scale space within a multi-dimensional feature space, comprising:
a feature analyzer initially processing features, comprising:
a feature extractor extracting the features from a plurality of data collections, each data collection characterized by a collection of features semantically-related by a grammar;
a database manager normalizing each feature and determining frequencies of occurrence and co-occurrences for the features for each of the data collections;
a mapper mapping the occurrence frequencies and the co-occurrence frequencies for each of the features into a set of patterns of occurrence frequencies and a set of patterns of co-occurrence frequencies with one such pattern for each data collection;
an unsupervised classifier selecting the pattern for each data collection and calculating similarity measures between each occurrence frequency in the selected pattern;
a scale space transformation projecting the occurrence frequencies onto a one-dimensional document signal in order of relative decreasing similarity using the similarity measures; and
a critical feature identifier deriving wavelet and scaling coefficients from the one-dimensional document signal.

2. A system according to claim 1, further comprising:
a preprocessor preprocessing each of the data collections prior to feature extraction to identify and logically remove non-probative content.

3. A system according to claim 1, further comprising:
a database record storing a single occurrence of each feature in normalized form.

4. A system according to claim 1, further comprising:
a feature frequency mapping arranging the patterns into a document feature matrix according to the data collection from which the features in each pattern were extracted.

5. A system according to claim 1, further comprising:
a similarity module calculating a distance measure between each occurrence frequency as a similarity measure.

6. A system according to claim 5, further comprising:
a defined variance bounding each of the similarity measures; and
a cluster module forming the occurrence frequencies into clusters, each cluster comprising at least one of the features with such a similarity measure falling within the variance.

7. A system according to claim 1, further comprising:
a pattern module forming each pattern as a vector in a multi-dimensional feature space; and
a projection module projecting the multi-dimensional feature space into the one-dimensional document signal.

8. A system according to claim 7, further comprising:
a self-organizing map of the multi-dimensional feature space formed prior to projection.

9. A system according to claim 1, further comprising:
a quantizer quantizing the one-dimensional document signal.

10. A system according to claim 9, further comprising:
an encoder encoding the quantized one-dimensional document signal.

11. A system according to claim 1, further comprising:
wavelet and scaling coefficients generated through a multiresolution analysis of the one-dimensional document signal.

12. A method for identifying critical features in an ordered scale space within a multi-dimensional feature space, comprising:
extracting features from a plurality of data collections, each data collection characterized by a collection of features semantically-related by a grammar;
normalizing each feature and determining frequencies of occurrence and co-occurrences for the feature for each of the data collections;
mapping the occurrence frequencies and the co-occurrence frequencies for each of the features into a set of patterns of occurrence frequencies and a set of patterns of co-occurrence frequencies with one such pattern for each data collection;
selecting the pattern for each data collection and calculating similarity measures between each occurrence frequency in the selected pattern;
projecting the occurrence frequencies onto a one-dimensional document signal in order of relative decreasing similarity using the similarity measures; and
deriving wavelet and scaling coefficients from the one-dimensional document signal.

13. A method according to claim 12, further comprising:
preprocessing each of the data collections prior to feature extraction to identify and logically remove non-probative content.

14. A method according to claim 12, further comprising:
storing a single occurrence of each feature in normalized form.

15. A method according to claim 12, further comprising:
arranging the patterns into a document feature matrix according to the data collection from which the features in each pattern were extracted.

16. A method according to claim 12, further comprising:
calculating a distance measure between each occurrence frequency as a similarity measure.

17. A method according to claim 16, further comprising:
defining a variance bounding each of the similarity measures; and
forming the occurrence frequencies into clusters, each cluster comprising at least one of the features with such a similarity measure falling within the variance.

18. A method according to claim 12, further comprising:
forming each pattern as a vector in a multi-dimensional feature space; and
projecting the multi-dimensional feature space into the one-dimensional document signal.

19. A method according to claim 18, further comprising:
generating a self-organizing map of the multi-dimensional feature space prior to projection.

20. A method according to claim 12, further comprising:
quantizing the one-dimensional document signal.

21. A method according to claim 20, further comprising:
encoding the quantized one-dimensional document signal.

22. A method according to claim 12, further comprising:
generating wavelet and scaling coefficients through a multiresolution analysis of the one-dimensional document signal.

23. A computer-readable storage medium for a device holding code for performing the method according to claim 12.

24. A system for abstracting semantically latent concepts extracted from a plurality of documents, comprising:
a concept analyzer extracting terms and phrases from a plurality of documents, each document comprising a collection of terms, phrases and non-probative words, parsing the terms and phrases into concepts and reducing the concepts into a single root word form, and accumulating a frequency of occurrence for each concept;
a map comprising the occurrence frequencies for each of the concepts mapped into a set of patterns of occurrence frequencies, one such pattern per document, arranged in a two-dimensional document feature matrix;
an unsupervised classifier iteratively selecting each pattern from the document feature matrix for each document and calculating similarity measures between each pattern;
a scale space transformation transforming the occurrence frequencies, beginning from a substantially maximal similarity value, into a one-dimensional signal in scaleable vector form ordered in sequence of relative decreasing similarity; and
a critical feature identifier deriving wavelet and scaling coefficients from the one-dimensional scale signal.

25. A system according to claim 24, further comprising:
a preprocessor preprocessing each of the documents prior to term and phrase extraction to identify and logically remove non-probative words for the documents.

26. A system according to claim 24, further comprising:
a variance bounding each of the similarity measures; and
a cluster module calculating, for each concept, a distance measure between each occurrence frequency and building clusters of concepts, each cluster comprising at least one of the concepts with the distance measure falling within the variance.

27. A system according to claim 24, further comprising:
a self-organizing map of the occurrence frequencies of each of the concepts.

28. A system according to claim 24, further comprising:
a quantizer quantizing the one-dimensional scale signal; and
an encoder encoding the quantized one-dimensional scale signal.

29. A system according to claim 24, further comprising:
wavelet and scaling coefficients generated through a multiresolution analysis of the one-dimensional scale signal.

30. A method for abstracting semantically latent concepts extracted from a plurality of documents, comprising:
extracting terms and phrases from a plurality of documents, each document comprising a collection of terms, phrases and non-probative words;
parsing the terms and phrases into concepts and reducing the concepts into a single root word form;
accumulating a frequency of occurrence for each concept;
mapping the occurrence frequencies for each of the concepts into a set of patterns of occurrence frequencies, one such pattern per document, arranged in a two-dimensional document feature matrix;
iteratively selecting each pattern from the document feature matrix for each document and calculating similarity measures between each pattern;
transforming the occurrence frequencies, beginning from a substantially maximal similarity value, into a one-dimensional signal in scaleable vector form ordered in sequence of relative decreasing similarity; and
deriving wavelet and scaling coefficients from the one-dimensional scale signal.

31. A method according to claim 30, further comprising:
preprocessing each of the documents prior to term and phrase extraction to identify and logically remove non-probative words for the documents.

32. A method according to claim 30, further comprising:
defining a variance bounding each of the similarity measures;
for each concept, calculating a distance measure between each occurrence frequency; and
building clusters of concepts, each cluster comprising at least one of the concepts with the distance measure falling within the variance.

33. A method according to claim 30, further comprising:
generating a self-organizing map of the occurrence frequencies of each of the concepts.

34. A method according to claim 30, further comprising:
quantizing the one-dimensional scale signal; and
encoding the quantized one-dimensional scale signal.

35. A method according to claim 30, further comprising:
generating wavelet and scaling coefficients through a multiresolution analysis of the one-dimensional scale signal.

36. A computer-readable storage medium for a device holding code for performing the method according to claim 30.

37. A system for abstracting semantically latent genetic subsequences extracted from a plurality of genetic sequences, comprising:
a genetic sequence analyzer extracting generic subsequences from a plurality of genetic sequences, each genetic sequence comprising a collection of at least one of genetic codes for DNA nucleotides and amino acids, and accumulating a frequency of occurrence for each genetic subsequence for each of the genetic sequences from which the genetic subsequences originated;
a map comprising the occurrence frequencies for each of the genetic subsequences mapped into a set of patterns of occurrence frequencies, one such pattern per genetic sequence, arranged in a two-dimensional genetic subsequence matrix;
an unsupervised classifier iteratively selecting each pattern from the genetic subsequence matrix for each genetic sequence and calculating similarity measures between each occurrence frequency in each selected pattern;
a scale space transformation projecting the occurrence frequencies, beginning from a substantially maximal similarity measure, onto a one-dimensional signal in scaleable vector form ordered in sequence of relative decreasing similarity; and
a critical feature identifier deriving wavelet and scaling coefficients from the one-dimensional scale signal.

38. A system according to claim 37, further comprising:
a preprocessor preprocessing each of the genetic sequences prior to extraction to identify and logically remove non-probative data from the genetic sequences.

39. A system according to claim 37, further comprising:
a variance bounding each of the similarity measures; and
a cluster module calculating, for each genetic subsequence, a distance measure between each occurrence frequency and building clusters of genetic subsequences, each cluster comprising at least one of the genetic subsequences with the distance measure falling within the variance.

40. A system according to claim 37, further comprising:
a self-organizing map of the occurrence frequencies of each of the genetic subsequences.

41. A system according to claim 37, further comprising:
a quantizer quantizing the one-dimensional scale signal; and
an encoder encoding the quantized one-dimensional scale signal.

42. A system according to claim 37, further comprising:
wavelet and scaling coefficients generated through a multiresolution analysis of the one-dimensional scale signal.

43. A method for abstracting semantically latent genetic subsequences extracted from a plurality of genetic sequences, comprising:
extracting generic subsequences from a plurality of genetic sequences, each genetic sequence comprising a collection of at least one of genetic codes for DNA nucleotides and amino acids;
accumulating a frequency of occurrence for each genetic subsequence for each of the genetic sequences from which the genetic subsequences originated;
mapping the occurrence frequencies for each of the genetic subsequences into a set of patterns of occurrence frequencies, one such pattern per genetic sequence, arranged in a two-dimensional genetic subsequence matrix;
iteratively selecting each pattern from the genetic subsequence matrix for each genetic sequence and calculating similarity measures between each occurrence frequency in each selected pattern;
projecting the occurrence frequencies, beginning from a substantially maximal similarity measure, onto a one-dimensional signal in scaleable vector form ordered in sequence of relative decreasing similarity; and
deriving wavelet and scaling coefficients from the one-dimensional scale signal.

44. A method according to claim 43, further comprising:
preprocessing each of the genetic sequences prior to extraction to identify and logically remove non-probative data from the genetic sequences.

45. A method according to claim 43, further comprising:
defining a variance bounding each of the similarity measures;
for each genetic subsequence, calculating a distance measure between each occurrence frequency; and
building clusters of genetic subsequences, each cluster comprising at least one of the genetic subsequences with the distance measure falling within the variance.

46. A method according to claim 43, further comprising:
generating a self-organizing map of the occurrence frequencies of each of the genetic subsequences.

47. A method according to claim 43, further comprising:
quantizing the one-dimensional scale signal; and
encoding the quantized one-dimensional scale signal.

48. A method according to claim 43, further comprising:
generating wavelet and scaling coefficients through a multiresolution analysis of the one-dimensional scale signal.

49. A computer-readable storage medium for a device holding code for performing the method according to claim 43.
